(19) United States
(12) Patent Application Publication
(10) Pub. No.: US 2007/0028713 A1
(43) Pub. Date: Feb. 8, 2007

(54) Removable, adhesive backed gripping device

(76) Inventor: Lee Ann Morgan, Santa Barbara, CA (US)

Correspondence Address: CHRISTIE, PARKER & HALE, LLP, PO BOX 7068, PASADENA, CA, 91109-7068, US

(21) Appl. No.: 11/354,751

(22) Filed: Feb. 14, 2006

Related U.S. Application Data
(60) Provisional application No. 60/700,524, filed on Jul. 18, 2005.

(51) Int. Cl. G05G 11/00

(52) U.S. Cl. 74/489

(57) ABSTRACT

Gripping devices for use with equestrian riding equipment are provided. The gripping device comprises a traction causing layer coated on one surface with a pressure-sensitive adhesive layer, which is covered by a release liner. The gripping device is applied to any surface involved in an interface between the rider and the horse or saddle. For example, the gripping device may be applied to the saddle, the riding boots or the chaps. The gripping devices are also used with non-equestrian equipment, such as surfboards, medical transport equipment, and personal motor crafts.

### CROSS-REFERENCE TO RELATED APPLICATION(S)

This application claims priority to and the benefit of U.S. Provisional Patent Application No. 60/700,524, entitled “REMOVABLE, ADHESIVE-BACKED EQUESTRIAN RIDING GRIP SYSTEM FOR ENGLISH OR WESTERN-TYPE SADDLES AND RIDING BOOTS OR RIDING CHAPS,” filed on Jul. 18, 2005 in the United States Patent and Trademark Office, the entire content of which is incorporated herein by reference.

### FIELD OF INVENTION

The invention is related to removable, adhesive backed gripping devices for improving traction at an interface between a rider and a mountable device or animal.

### BACKGROUND OF THE INVENTION

In equestrian sports, riding safety largely depends on the rider's grip around the barrel of the horse. Conventional leather riding saddles, boots and chaps, while durable, are not particularly safe and often do not afford the rider the good grip necessary to ride safely. When using such leather, suede and synthetic materials, the rider must use his leg muscles to maintain balance and control of the horse. Such constant use of leg muscles results in muscle fatigue which creates safety risks such as a loss of balance and the risk of falling off of the horse.

In addition, leather riding materials become worn and stretch over time, and absorb dirt and perspiration, making the materials slick and further decreasing grip. However, because saddles, boots and chaps are expensive necessities, riders often continue to use them even after they have become worn, stretched and slick. The continued use of such equipment is neither safe nor efficient. These same concerns may also arise in connection with pieces of equipment that contact a person's body during riding or mounting and require good grip for optimum performance.

### SUMMARY OF THE INVENTION

The present invention relates to a gripping device that can be attached to conventional riding materials to both improve a rider's grip and increase the life and use of the riding materials. The inventive gripping device comprises a gripping layer, a pressure-sensitive adhesive layer on one surface of the gripping layer, and a release liner coupled to the adhesive layer. The gripping layer is made of a suitable traction-causing material and may have an exposed surface that is smooth or textured.

The pressure-sensitive adhesive layer may comprise any pressure-sensitive adhesive suitable for application to conventional riding materials, such as saddles, chaps and boots. In one embodiment, the pressure-sensitive adhesive layer comprises a repositionable adhesive that can be applied to a surface, removed from the surface and re-applied to the same or a different surface without leaving adhesive residue on the surface(s).

The release liner can be any known release liner for use with pressure-sensitive adhesives. The liner covers the surface of the adhesive layer and is removed from the gripping device before application of the device to the intended riding equipment.

When used on a saddle, the inventive gripping devices can be placed anywhere suitable for increasing the rider's grip. In one embodiment, the gripping device is positioned on at least one leg flap of the saddle for engaging with the rider's lower leg. In another embodiment, the gripping device is positioned on the seat of the saddle. Alternatively, the gripping device may be positioned on at least one twist of the saddle for engaging the rider's thigh or knee. In an alternative embodiment, a saddle gripping kit includes the first and second gripping devices adapted for positioning on each leg flap, third and fourth gripping devices adapted to be positioned on each twist, and a fifth gripping device adapted to be positioned on the seat. The third and fourth gripping devices may also be combined in a single device.

The gripping device may also be used on riding apparel, such as boots. In this embodiment, the gripping device is positioned on the side of the boot that contacts the leg flap of the saddle. The gripping device may be sized and shaped in any manner such that at least a portion of the device contacts the saddle. In another embodiment, a boot gripping kit includes first and second gripping devices adapted to be positioned on each riding boot.

When used on chaps, pants or other types of apparel, the gripping device may be positioned anywhere on the chaps, pants or other types of apparel suitable for increased grip. In one embodiment, the gripping device is positioned over the area of the pants covering the rider's calf or lower leg. In another embodiment, the gripping device is positioned over the area of the apparel covering the rider's thigh or upper leg. Alternatively, the gripping device is positioned over the area of the rider's apparel covering the rider's buttock. In another alternative embodiment, a rider gripping kit includes first and second gripping devices positioned over each of the rider's calves or lower legs, third and fourth gripping devices positioned over each of the rider's thighs or upper legs, and fifth and sixth gripping devices positioned over each of the rider's buttocks. In each of these embodiments, the gripping device(s) is positioned on the apparel, such as chaps, pants, breeches or boots, such that the gripping device contacts the saddle.

Although principally described with respect to riding equipment, the gripping devices of the present invention may be used with any piece of equipment that contacts a person's body and which requires good grip for optimum performance. For example, the gripping device can be used with any personal motor craft, such as a motorcycle, watercraft or snow craft, designed for riding and requiring grip for control and operation. In one embodiment, a gripping device is positioned on the seat of a motorcycle or on the gas tank. In another embodiment, a motorcycle gripping kit includes first and second gripping devices adapted to be positioned on the right and left sides of the gas tank, and a third gripping device adapted to be positioned on the seat. Similar gripping devices are used for similar motor crafts, such as watercrafts and snow crafts.

The gripping devices may also be used on non-motorized equipment such as surfboards, car seats, wheelchairs and medical transport devices including gurneys and stretchers for which good grip is essential. In one exemplary embodiment, a surfboard gripping kit includes first, second, and third gripping devices separated from each other, each gripping device being contoured to its respective portion of the surfboard. In another embodiment, a seat gripping kit includes first and second gripping devices contoured to fit the seat back and bottom of a chair such as a wheelchair or a car seat.

### BRIEF DESCRIPTION OF THE DRAWINGS

The above and other features and advantages of the present invention will become more apparent by reference to the following detailed description when considered in conjunction with the accompanying drawings in which:

FIG. 1 is a cross-sectional view of a gripping device according to one embodiment of the present invention;

FIG. 2a is a schematic of a boot gripping kit according to one embodiment of the present invention;

FIG. 2b is an exploded elevational view of a pair of English riding boots incorporating the boot gripping kit of FIG. 2a;

FIG. 3a is a schematic of an English riding saddle gripping kit according to one embodiment of the present invention;

FIG. 3b is an exploded elevational view of one side of an English riding saddle incorporating the English riding saddle gripping kit of FIG. 3a;

FIG. 3c is an exploded elevational view of the other side of the English riding saddle of FIG. 3b incorporating the English riding saddle gripping kit of FIG. 3a;

FIG. 4 is a top view of the saddle of FIGS. 3b and 3c;

FIG. 5a is a schematic of a Western-type riding saddle gripping kit according to another embodiment of the present invention;

FIG. 5b is an exploded elevational view of one side of a Western-type saddle incorporating the Western-type saddle gripping kit of FIG. 5a;

FIG. 5c is an exploded elevational view of the other side of the Western-type saddle of FIG. 5b incorporating the Western-type saddle gripping kit of FIG. 5a;

FIG. 6 is a top view of the saddle of FIGS. 5b and 5c;

FIG. 7a is a schematic of a motor craft gripping kit according to yet another embodiment of the present invention;

FIG. 7b is an exploded elevational view of one side of the motor craft incorporating the motor craft gripping kit of FIG. 7a;

FIG. 7c is an exploded elevational view of the other side of the motor craft of FIG. 7b incorporating the motor craft gripping kit of FIG. 7a;

FIG. 8 is a top view of the seat of the motor craft of FIGS. 7b and 7c;

FIG. 9a is a schematic of a surfboard gripping kit according to still another embodiment of the present invention;

FIG. 9b is an exploded elevational view of a surfboard incorporating the surfboard gripping kit of FIG. 9b;

FIG. 10a is a schematic of a seat gripping kit according to an alternative embodiment of the present invention;

FIG. 10b is an exploded elevational view of a seat incorporating the seat gripping kit of FIG. 10a;

FIG. 11a is a schematic of a rider gripping kit according to another alternative embodiment of the present invention; and

FIG. 11b is an exploded elevational view of a pair of pants incorporating the rider gripping kit of FIG. 11a.

### DETAILED DESCRIPTION OF THE INVENTION

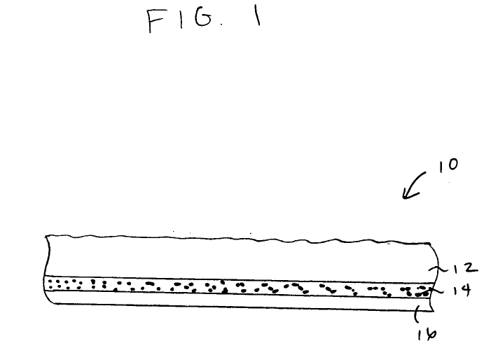

As shown in FIG. 1, a gripping device 10 according to one embodiment of the present invention comprises a gripping layer 12, a pressure-sensitive adhesive layer 14 on one surface of the gripping layer 12 and a release liner 16 coupled to the adhesive layer 14. The gripping layer 12 is made of a suitable traction-creating material and may have an exposed surface that is either smooth or textured. Any material that causes traction and is both flexible and durable can be used as the traction-creating material. One nonlimiting example of a suitable traction-creating material for the gripping layer 12 is neoprene, such as Grip-All Textured Neoprene Rubber available from McMaster. Another suitable manufacturer of neoprene for use with the present invention is Atlantic Rubber Company. However, any other natural or synthetic rubbers can also be used.

The traction-creating layer 12 may be provided in any color, such as tan, brown or black. The color of the traction-creating layer 12 may depend on the equipment upon which the gripping device 10 is intended to be applied. For example, a gripping device attached to a brown leather saddle may have a traction-creating layer 12 made of a corresponding brown color.

As noted above, a surface of the traction-creating layer 12 may be smooth or textured. A textured surface provides increased traction and improved grip. A textured surface also better withstands normal wear and tear, thereby increasing the life of the gripping device. When textured, the surface of the traction causing layer 12 may have any texture suitable to increase grip. For example, the surface may comprise a plurality of indentations or striations.

The pressure-sensitive adhesive layer 14 may be comprised of any pressure-sensitive adhesive suitable for application to conventional riding materials, such as saddles, chaps and boots. In one embodiment, the pressure-sensitive adhesive layer 14 comprises a repositionable adhesive that can be applied to a surface, removed from the surface and re-applied to the same or a different surface without leaving adhesive residue on the surface(s).

The release liner 16 can be any known release liner for use with pressure-sensitive adhesives. The liner 16 covers the surface of the adhesive layer and is removed from the gripping device before application of the device to the intended surface.

The gripping device 10 can have any thickness suitable for increasing grip and control of a human-operated machine or device. In one embodiment, the gripping device 10 has a thickness ranging from about 1/16th to about ⅛th of an inch. If the gripping device 10 is thicker than about ⅛th of an inch, control is diminished; and if the gripping device 10 is thinner than about 1/16th of an inch, durability is diminished.

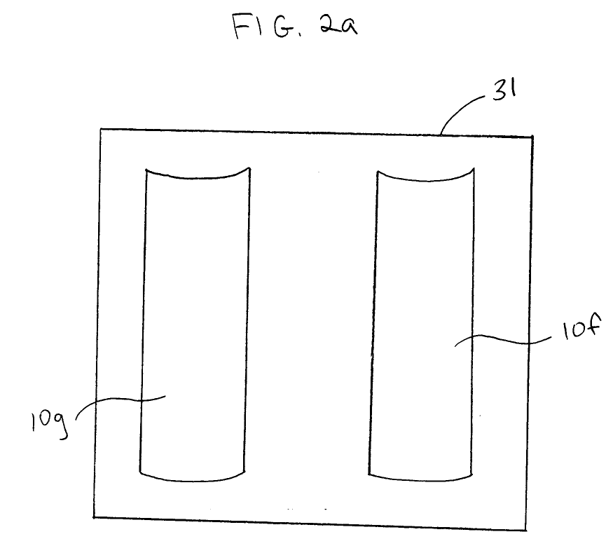

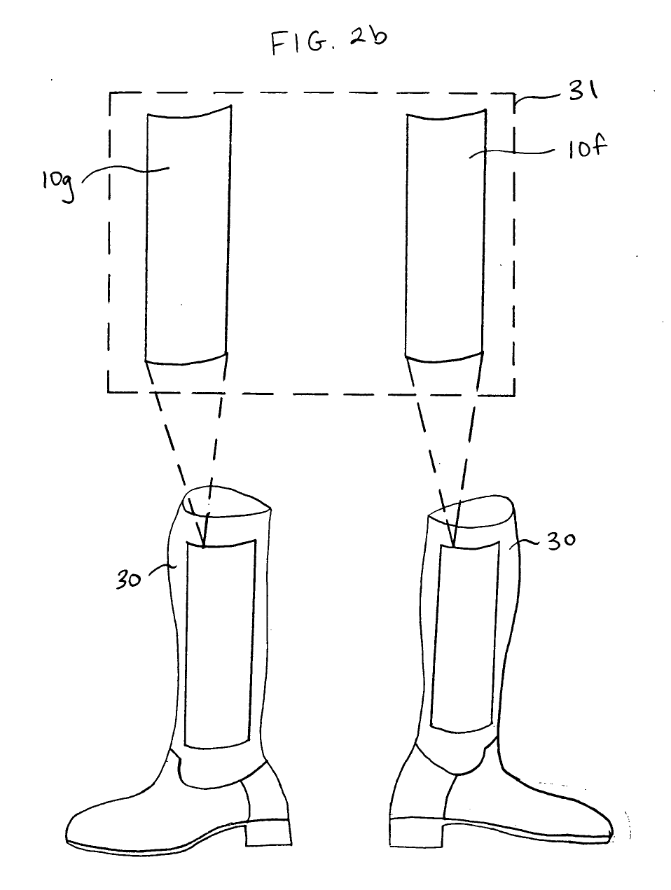

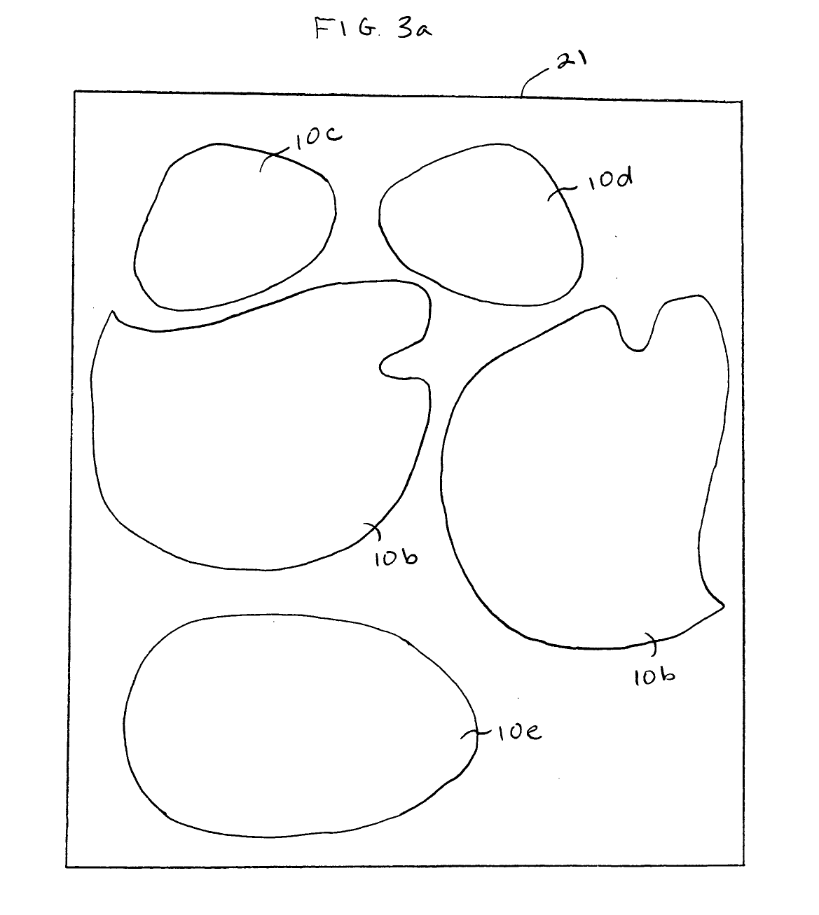

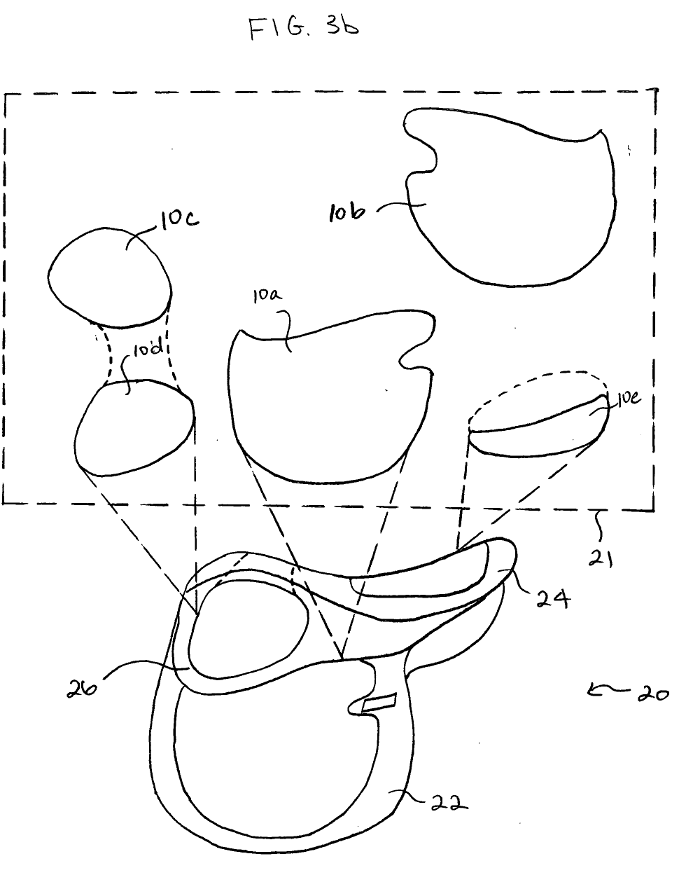

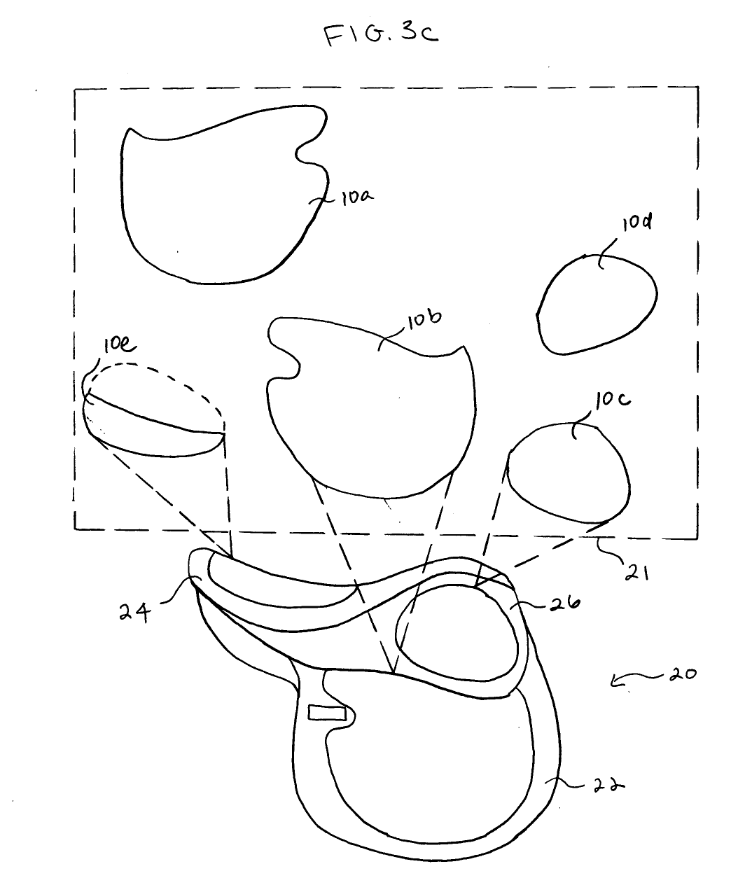

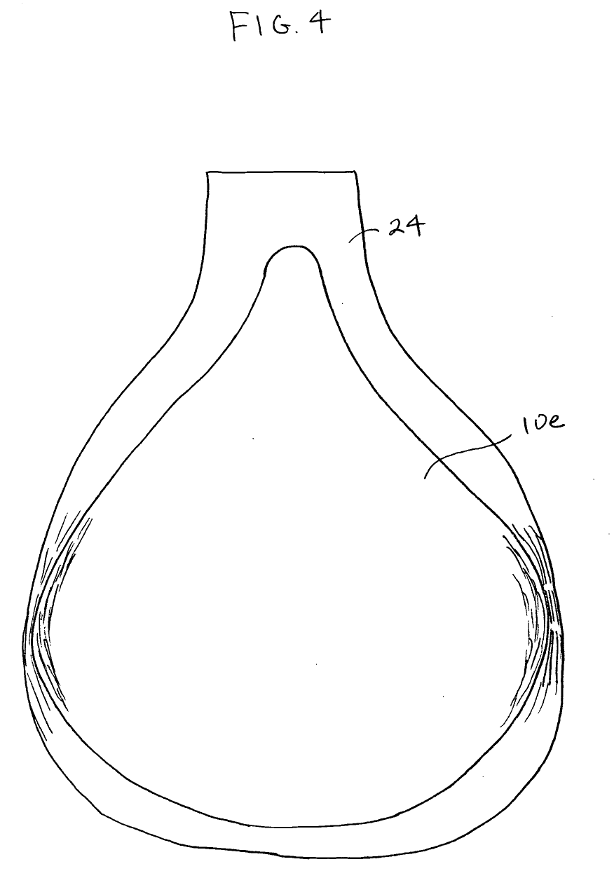

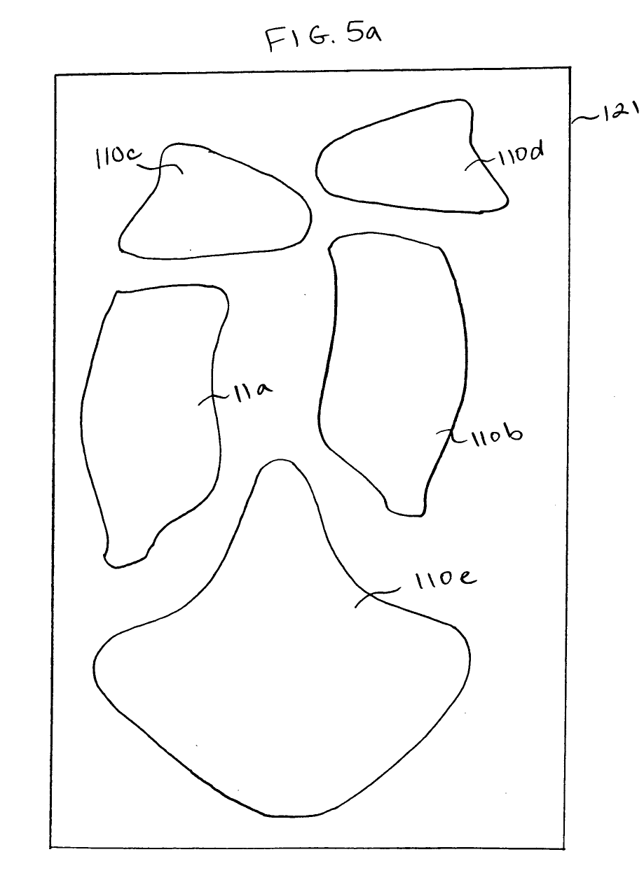

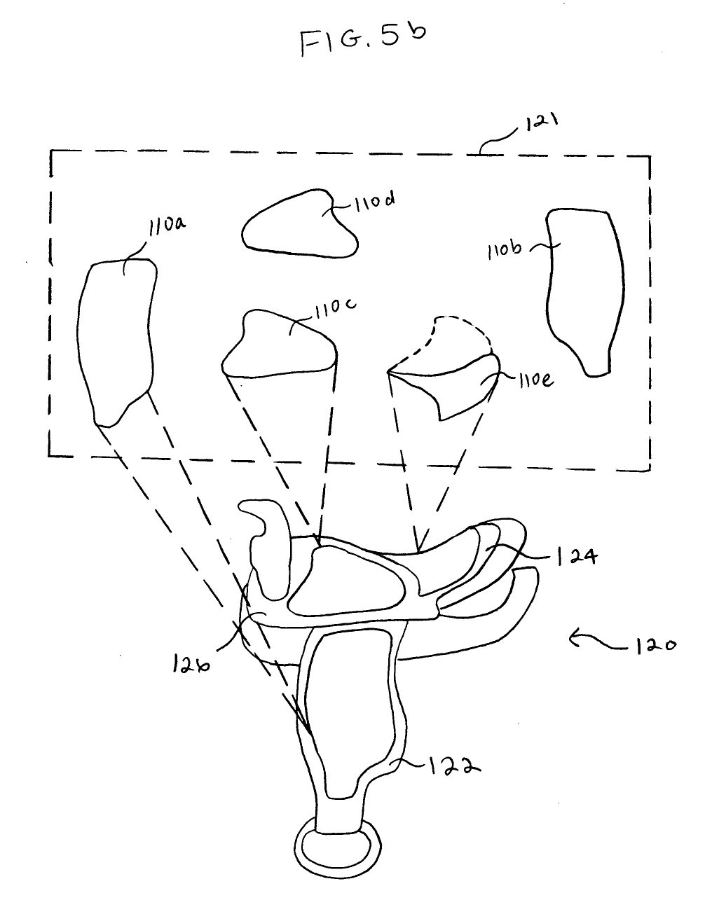

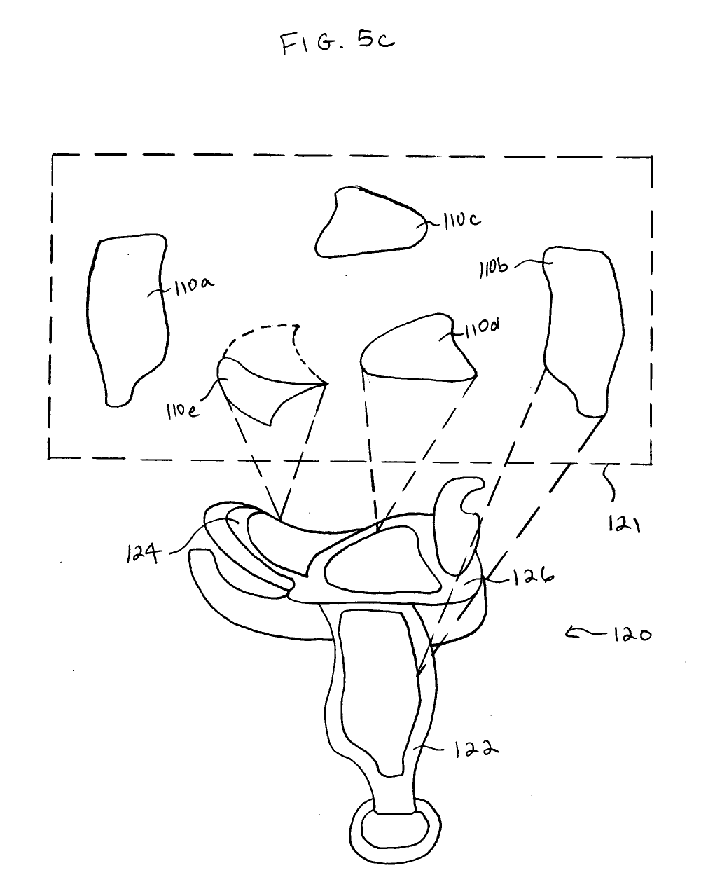

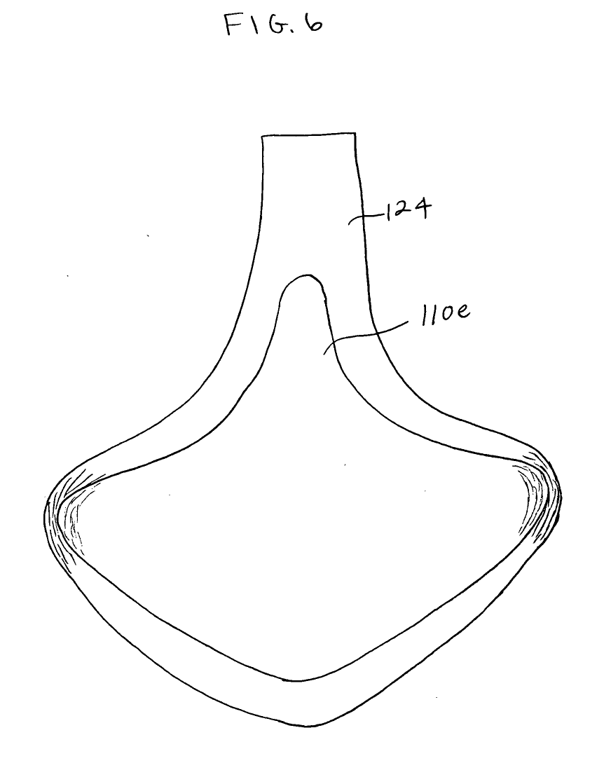

Once assembled, the gripping device 10 is sized and shaped to conform to an interface between a rider and an object, such as a saddle for a horse. In general, the material for a gripping device 10 is manufactured in sheet or roll form, and then cut to size or shape for the intended application. The gripping device 10 is shaped by cutting or stamping it from the sheet or roll in the desired shape, which is selected based on the intended use of the gripping device 10. The device may be formed using a clicker press with a cutting die. For example, as shown in FIGS. 3b, 3c, 4, 5b, 5c and 6, a gripping device designed for use on a saddle 20 may be sized and shaped to fit on a leg flap 22, seat 24 or twist 26 of the saddle. As shown in FIGS. 3b, 3c and 4 depicting an English riding saddle and FIGS. 5b, 5c and 6 depicting a Western-type saddle, different types of saddles may have differently shaped leg flaps, seats and twists, requiring differently sized and shaped gripping devices. Alternatively, a gripping device 10 designed for use on a riding boot 30 (shown in FIG. 2b) may be sized and shaped to fit on the surface of the boot 30 which contacts the leg flap 22 of the saddle 20 or the horse.

When used on an English riding saddle 20, as shown in FIGS. 3b, 3c and 4, the inventive gripping devices 10 can be placed anywhere suitable for increasing the rider's grip or hold around the horse. In one embodiment, the gripping device 10 is positioned on at least one leg flap 22 of the saddle 20 for engaging the rider's lower leg. In another embodiment, the gripping device 10 is positioned on the seat 24 of the saddle 20 for engaging the rider's buttocks. Alternatively, the gripping device may be positioned on at least one twist 26 of the saddle 20 for engaging the rider's thigh or knee. In another alternative embodiment, an English riding saddle gripping kit 21 (shown in FIGS. 3a, 3b, 3c and 4) includes first and second gripping devices 10a and 10b adapted to be positioned on each leg flap 22, third and fourth gripping devices 10c and 10d adapted to be positioned on each twist 26, and a fifth gripping device 10e adapted to be positioned on the seat 24. In another embodiment, a Western-type riding saddle gripping kit 121 (shown in FIGS. 5a, 5b, 5c and 6) includes first and second gripping devices 110a and 110b adapted to be positioned on each leg flap 122, third and fourth gripping devices 110c and 110d adapted to be positioned on each twist 126, and a fifth gripping device 110e adapted to be positioned on the seat 124. Such saddle gripping kits provide the rider with maximum grip, thereby decreasing muscle fatigue, and increasing riding safety and efficiency. Although illustrated and described in connection with English and Western-type saddles, it is understood that the gripping devices of this embodiment can be used with any saddle type, including but not limited to Australian, Polo, Dressage, Endurance saddles and bareback pads.

As shown by way of example in FIG. 3b, the gripping devices 10c and 10d may be combined into one gripping device. The combined gripping device would have the shape depicted by the phantom lines shown in FIG. 3b. Other gripping devices in other embodiments of the kits may also be similarly combined.

In an alternative embodiment, the gripping device 10 is used on riding boots 30. In this embodiment, the gripping device 10 is positioned on at least one riding boot 30 and is positioned on the side of the boot 30 that contacts the leg flap 22 of the saddle 20 or the body of the horse. The gripping device 10 may be sized and shaped in any manner such that at least a portion of the device contacts the saddle 20 or the horse. As shown in FIG. 2b, the gripping device may be substantially rectangular in shape. However, the gripping device may also be circular, ovular, or any other suitable shape. In another embodiment, a boot gripping kit 31 (shown in FIGS. 2a and 2b) includes first and second gripping devices 10f and 10g adapted to be positioned on each riding boot 30. This boot gripping kit 31 affords the rider better grip of the horse with his lower legs, decreasing the amount of muscular control required to maintain grip of the horse, thereby increasing riding safety and efficiency.

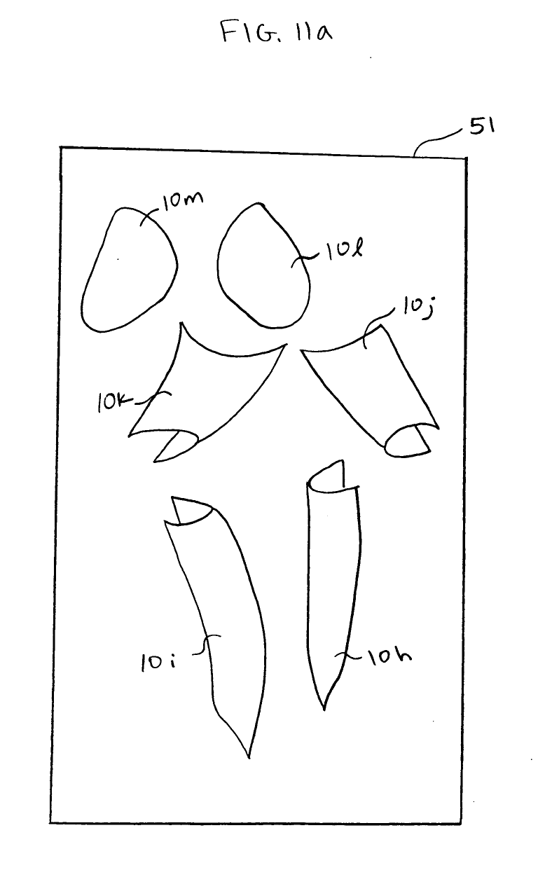

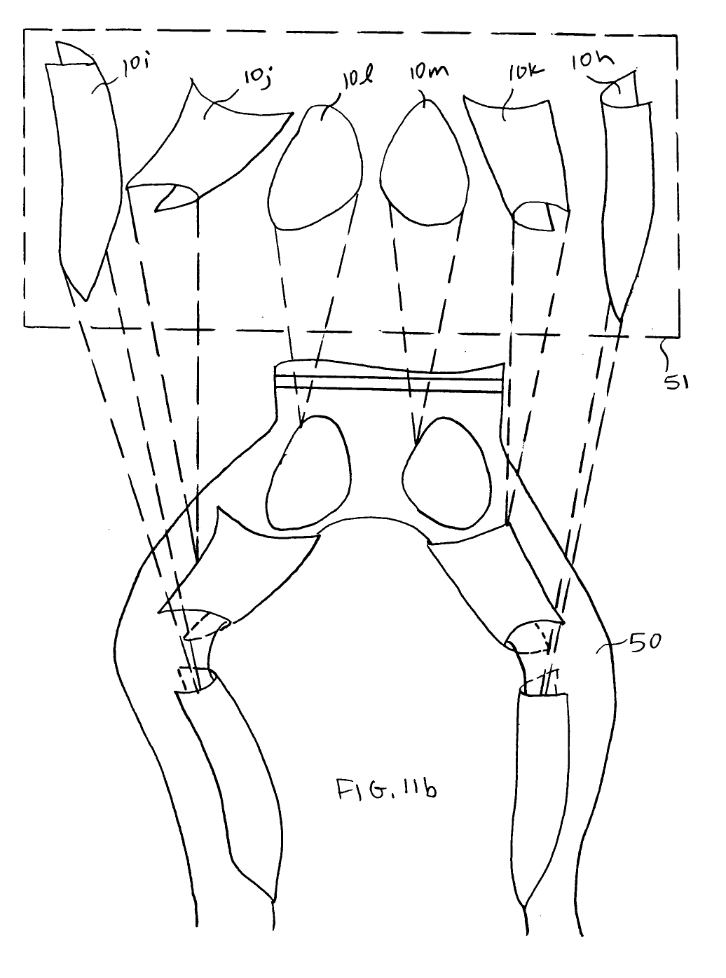

The gripping device may also be used on a rider's chaps, breeches, jeans, pants or other riding apparel 50, as shown in FIGS. 11a and 11b. In this embodiment, the gripping device 10 may be positioned anywhere on the apparel 50 suitable for increasing grip. For example, the gripping device 10 may be positioned over the area of the apparel 50 covering the rider's calf or lower leg. In another embodiment, the gripping device 10 is positioned over the area of the apparel 50 covering the rider's thigh or upper leg. Alternatively, the gripping device 10 is positioned over the area of the pants covering the rider's buttock or seat. In another alternative embodiment, a rider gripping kit 51 includes first and second gripping devices 10h and 10i positioned over each of the rider's calves or lower legs, third and fourth gripping devices 10j and 10k positioned over each of the rider's thighs or upper legs, and fifth and sixth gripping 10l and 10m devices positioned over each of the rider's buttocks. In each of these embodiments, the gripping device(s) is positioned on the chaps or pants such that the gripping device contacts at least a portion of the saddle 20 or object to be controlled. Although illustrated and described as attached to a rider's apparel, it is understood that the gripping devices according to this embodiment may be placed on any type of apparel or directly on the rider's skin, if so desired.

The various kits described above may be comprised of the individual gripping devices assembled together and placed in a single package. In this way, a user of the devices would have readily available in one package the gripping devices that might be needed for a particular application. Any of a number of well known packaging methods may be used to package the devices.

To apply the devices, the release liner is first removed and the devices applied to the desired surface such that the pressure sensitive adhesive contacts the desired surface and the gripping surface faces outwardly. When a repositionable pressure sensitive adhesive is used, the devices may be removed and repositioned should a change in position be desired.

In a preferred approach to applying and removing the devices, the gripping devices are applied to a clean, dry surface. A paper-backed release liner is peeled off of the gripping device. Slowly. The backing can be re-used if desired. If the gripping device is dropped in the dirt and it lands adhesive side down, a sponge, mild soap, and lukewarm water may be used to gently remove the dirt. It may be rinsed with clean water and let to air dry before re-applying to an object. The adhesive will stick again after being washed gently.

To apply, the gripping device is preferably sited over the object. The gripping device is then slowly pressed onto the object starting from one edge of the gripping device. The gripping device is applied using a rolling motion, to the opposite edge of the gripping device.

Upon applying the whole gripping device, pressure may be applied over the entire gripping device with the palms to assure the complete contact of gripping device and object.

When the gripping device is being removed or repositioned, the palm of the hand is preferably used to slowly press onto one edge of the gripping device and slowly “roll” that edge of the gripping device toward the opposite edge, as if in the process of rolling up a tortilla, thus leaving the gripping device rolled-up in a tube shape.

When removing the gripping device from a smooth leather object, rapidly “tearing” the gripping device off should preferably be avoided to prevent leaving bits of adhesive on the leather, or lifting off tiny, pin-sized spots from the leather's surface dye, especially if the leather is older and worn.

The gripping device can then be re-applied if desired, by “unrolling” it back onto the object from one edge to the other, using slow palm pressure.

Should the adhesive layer on a gripping device lose its effectiveness, double-stick tape may be used to adhere the gripping device to an object.

A gripping device may also be used as a space filler (shim) between a saddle's outer and inner flaps, or between the saddle and the saddle pad.

When used in connection with equestrian riding equipment, the gripping devices of the present invention improve a rider's grip of the horse. Grip is extremely important while riding because grip establishes balance and control of the horse, and the better the rider's grip on the horse, the better the rider is able to communicate commands to and thus control the horse. However, maintaining sufficient grip is difficult, especially when riding for an extended period of time. While riding, the horse's body moves both horizontally and vertically in various manners and speeds depending on whether the horse is walking, trotting, cantering, etc. This constant motion requires the rider to utilize his leg muscles to maintain grip and balance, and the constant use of leg muscles causes muscle fatigue.

The improved grip provided by the inventive gripping devices reduces muscle fatigue, thereby increasing riding safety and efficiency. The reduction in muscle fatigue results in a more enjoyable riding session, and enables the rider to ride for a longer period of time. In addition, the increased grip enhances the rider's control of the horse and improves the rider's ability to communicate commands to the horse. This increased control and ability to communicate commands to the horse is especially important for beginning riders and for use on young horses in early stages of training.

In addition to improving grip and riding safety, the gripping devices of the present invention increase the life of the riding equipment, whether new or already used. Because riding equipment is expensive, beginning riders often purchase previously owned equipment. However, as noted above, the leather materials of the riding equipment become worn and stretched over time, making grip and control of the horse difficult, especially for the beginning rider. Using the gripping devices of the present invention on such previously owned equipment protects the underlying surface of the equipment and improves grip, enabling the beginning rider to enjoy the grip and control necessary to learn properly. In addition, the gripping devices of the present invention provide an inexpensive alternative to purchasing expensive, brand new riding equipment, and can be simply removed and discarded when they become worn and begin to lose traction. New gripping devices may then be used in their place.

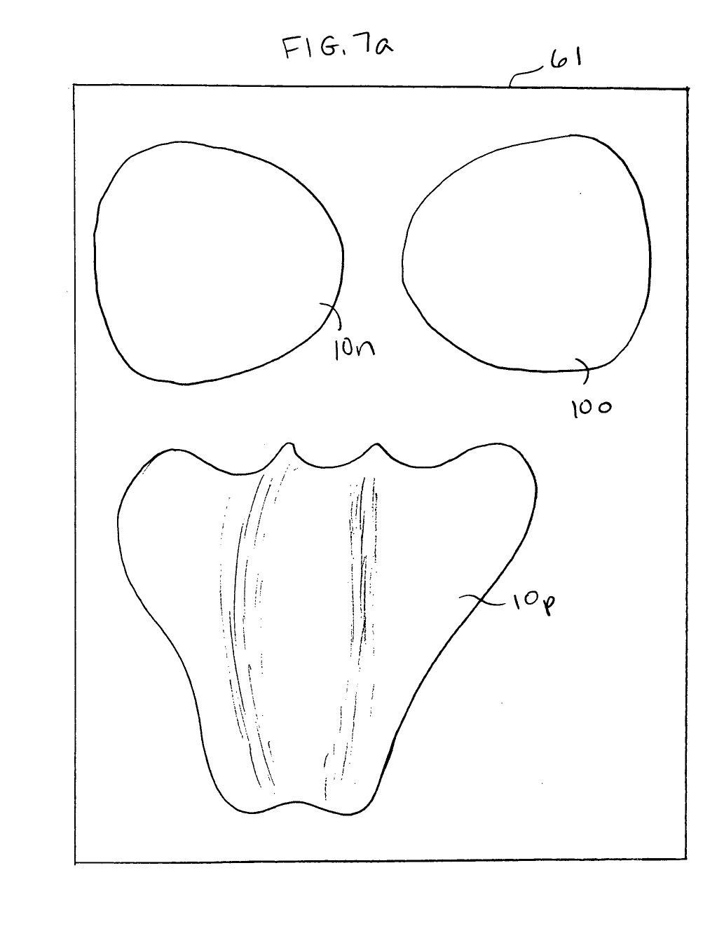

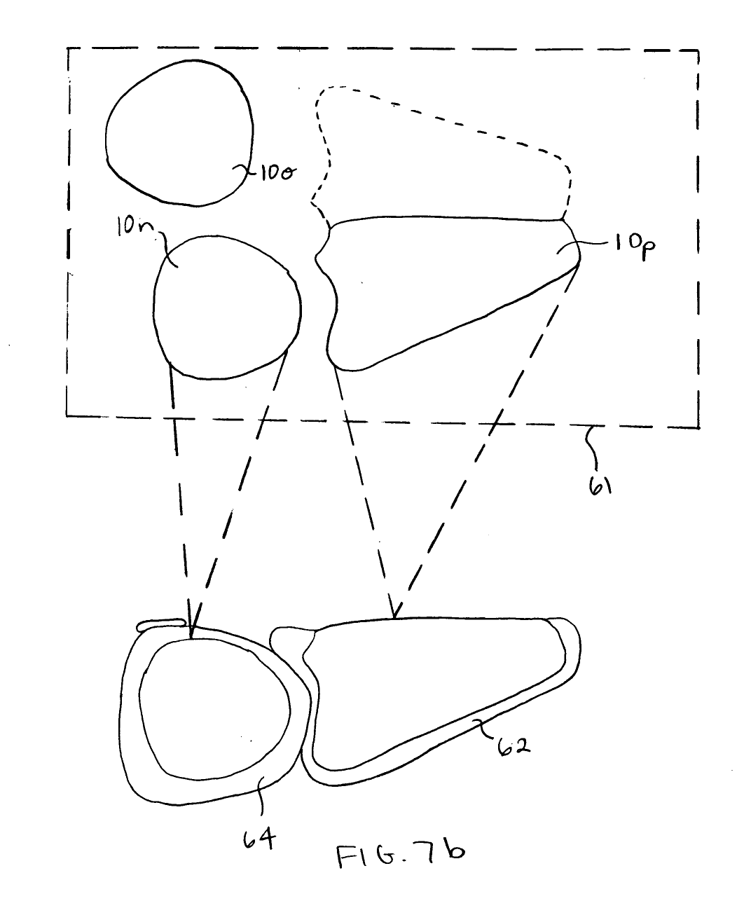

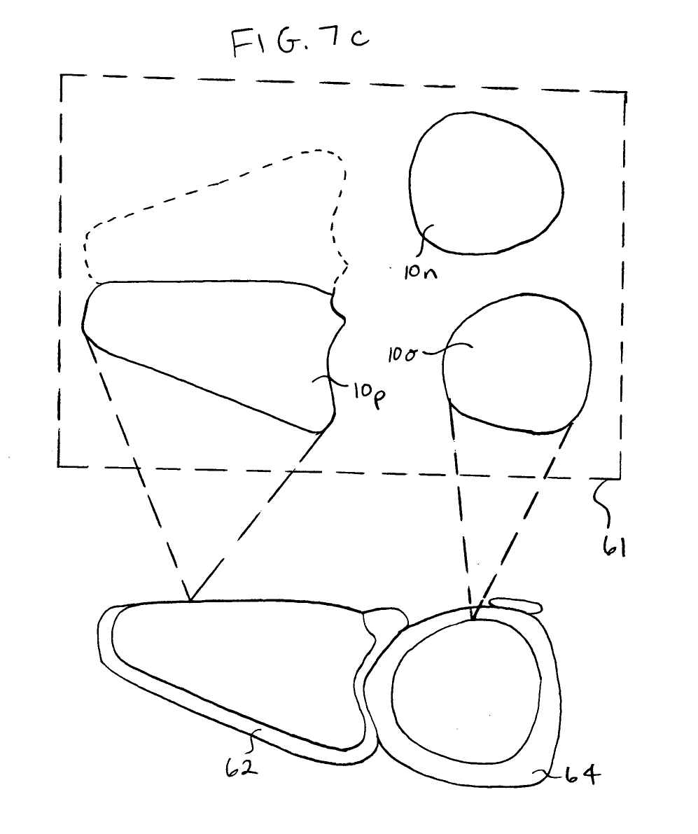

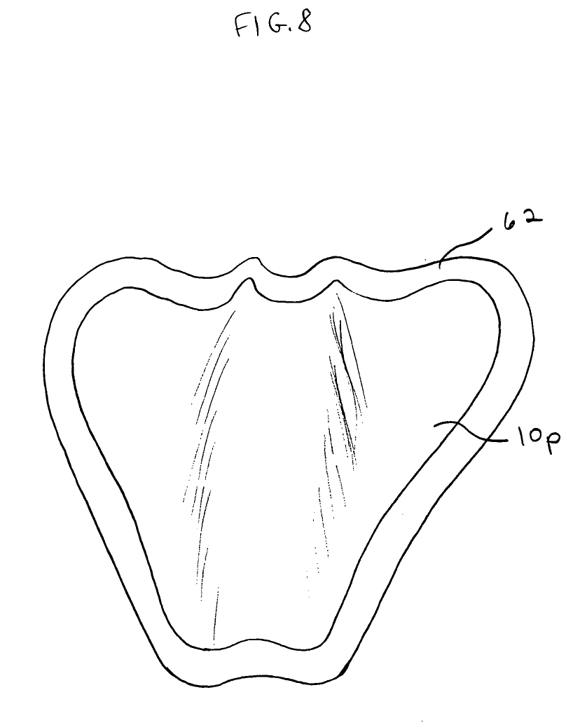

Although principally described with respect to equestrian equipment, the gripping devices 10 of the present invention can be used with any piece of equipment that, when operated, contacts a person's body and requires good grip for optimum performance. For example, the gripping devices 10 can be used with any personal motor craft, such as a motorcycle, watercraft or snow craft designed for riding and requiring grip for control and operation. In one embodiment, as shown in FIGS. 7b, 7c and 8, a gripping device is positioned on the seat 62 or gas tank 64 of a motor craft. In another embodiment, as shown in FIGS. 7a, 7b, 7c and 8, a motor craft gripping kit 61 includes first and second gripping devices 10n and 10o adapted to be positioned on the right and left sides of the gas tank 64, and a third gripping device 10p adapted to be positioned on the seat 62.

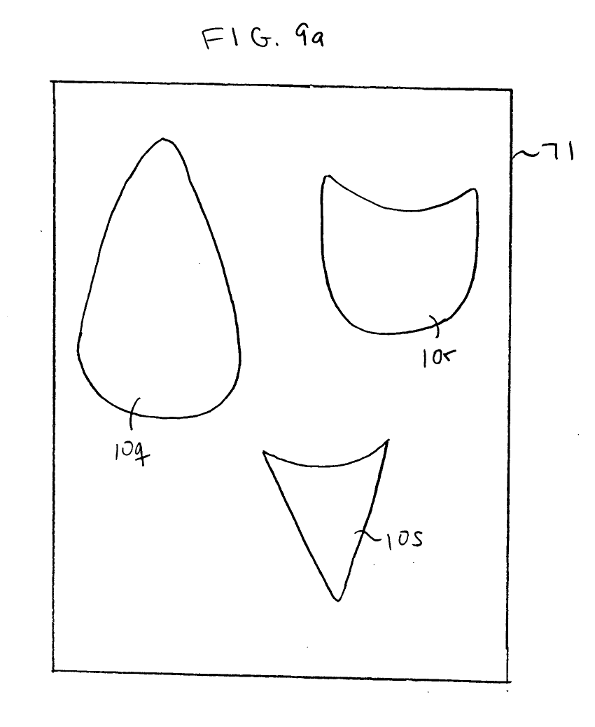

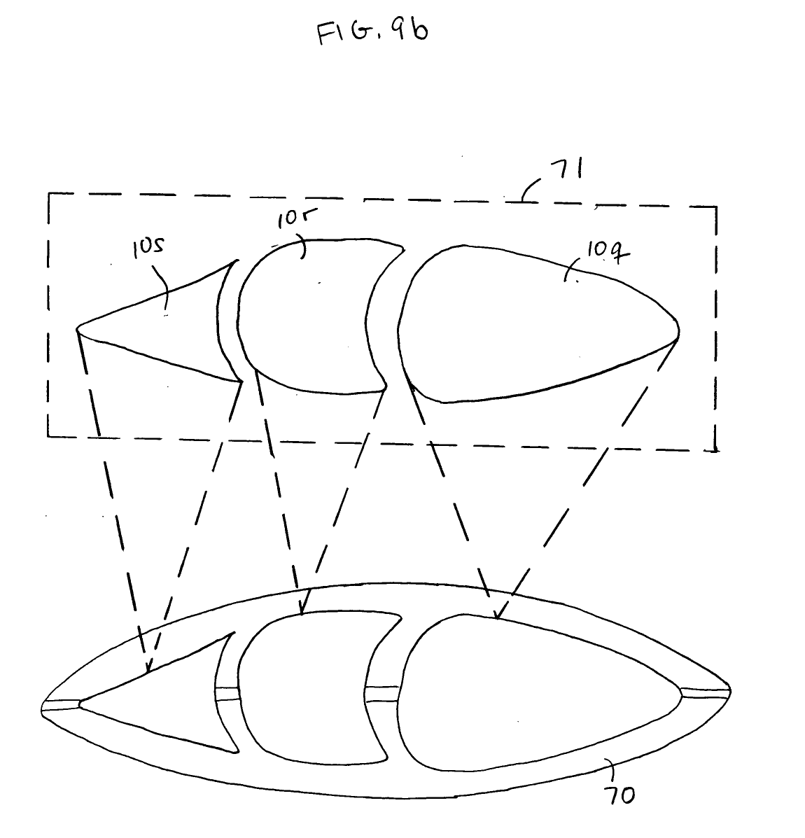

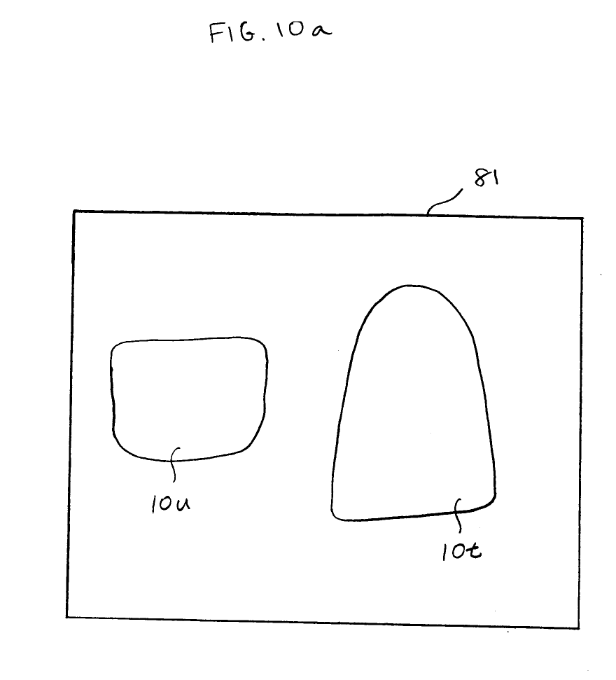

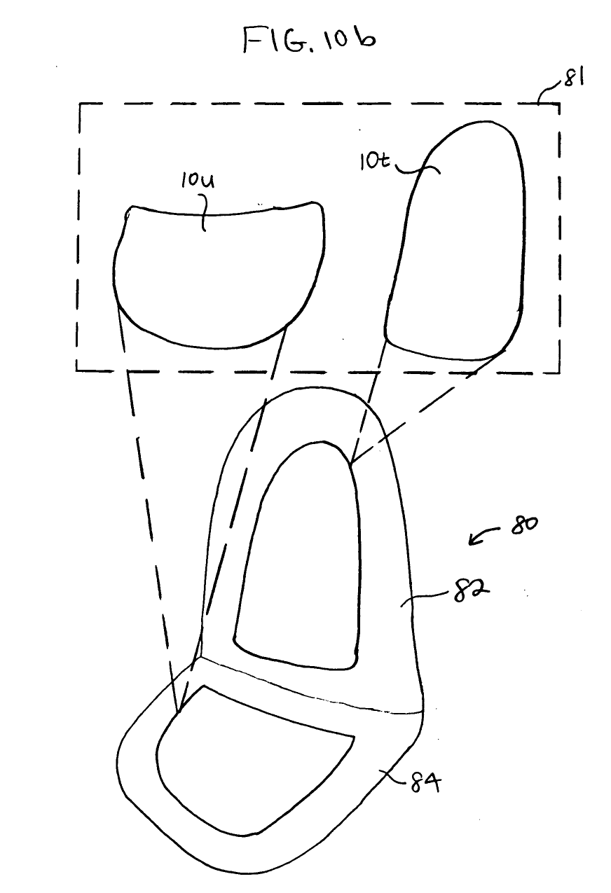

The gripping devices of the present invention may also be used on non-motorized equipment designed for human operation, such as surfboards, car seats, wheelchairs and medical transport devices including gurneys and stretchers for which good grip is essential. In one exemplary embodiment, as shown in FIGS. 9a and 9b, a surfboard gripping kit 71 includes first, second and third gripping devices 10q, 10r and 10s positioned on the surface of the surfboard 70 which contacts the surfer. The gripping devices 10q, 10r and 10s are separated from each other on the surfboard 70 and each gripping device is contoured to its respective portion of the surfboard 70. In another embodiment, as shown in FIGS. 10a and 10b, a seat gripping kit 81 includes a first gripping device 10t contoured to fit the seat back 82 of a seat 80 and a second gripping device 10u contoured to fit the bottom 84 of the seat 80. The seat 80 may be any seat suitable for human occupation, such as a chair, a wheelchair or a car seat. Such seat gripping kits 81 prevent a person from falling out of the seat during transport.

The gripping devices of the present invention may take any suitable shape so long as they fit within the intended area and provide sufficient grip. In addition to standard shapes such as rectangles, squares, circles and ovals, the gripping devices may be sized and shaped in a decorative manner to personalize the equipment to which the device is attached. For example, the gripping device may shaped like a flower or other decorative design.

The various kits described above, in an alternative embodiment, could contain one or more oversized gripping devices. A rider or other user could then trim the gripping devices using a scissors or other cutting implement to the size and shape that will best fit the specific dimensions of their own saddle or seat. In this way, the rider or other user could customize the gripping material more exactly to the contours of their saddles or seats.

For example, another embodiment of a saddle, motorcycle or motor craft kit, would comprise three separate rectangles, each being approximately 15 by 20 inches. The kit might also comprise a cutting implement if desired. The rider or other user would then use the gripping devices in the kit by trimming them to a desired size and shape. When a repositionable adhesive is used, the rider or other user could iteratively apply the gripping device, trim it, reapply it and so on as needed to get an exact fit.

The preceding description has been presented with reference to certain exemplary embodiments of the present invention. However, workers skilled in the art and technology to which this invention pertains will appreciate that alterations and changes to the described embodiments may be practiced without meaningfully departing from the principal, spirit and scope of this invention. Accordingly, the foregoing description should not be read as pertaining only to the precise embodiments described and illustrated in the accompanying drawings, but rather should be read consistent with and as support for the following claims which are to have their fullest and fairest scope.

What is claimed is:

1. A gripping device comprising:
a traction-causing layer;
a pressure-sensitive adhesive layer applied to a surface of the traction causing layer; and
a release liner removably attached to the pressure-sensitive adhesive layer,
wherein the gripping device is sized and shaped to form an interface between an object and a portion of a person's body.

2. The gripping device of claim 1, wherein the traction-causing layer comprises neoprene.

3. The gripping device of claim 1, wherein the gripping device has a thickness ranging from about 1/16th to about ⅛th of an inch.

4. The gripping device of claim 1, wherein the pressure-sensitive adhesive layer comprises a removable and repositionable pressure-sensitive adhesive.

5. The gripping device of claim 1, wherein a surface of the traction causing layer on which the pressure-sensitive adhesive is not positioned is textured.

6. The gripping device of claim 1, wherein the gripping device is sized and shaped to fit on a component of a saddle.

7. The gripping device of claim 6, wherein the component of the saddle is selected from the group consisting of leg flaps, seats and twists.

8. The gripping device of claim 1, wherein the gripping device is sized and shaped to fit on a component of a motor craft.

9. The gripping device of claim 8, wherein the motor craft is selected from the group consisting of motorcycles, watercrafts and snow crafts.

10. The gripping device of claim 8, wherein the component of the motor craft is selected from the group consisting of seats and gas tanks.

11. A saddle gripping kit comprising first, second, third, fourth and fifth gripping devices according to claim 1, wherein:
the first gripping device is sized and shaped to fit on a first leg flap of the saddle;
the second gripping device is sized and shaped to fit on a second leg flap of the saddle;
the third gripping device is sized and shaped to fit on a left twist of the saddle;
the fourth gripping device is sized and shaped to fit on a right twist of the saddle; and
the fifth gripping device is sized and shaped to fit on a seat of the saddle.

12. A boot gripping kit comprising first and second gripping devices according to claim 1, wherein:
the first gripping device is sized and shaped to fit on a surface of a right riding boot;
the second gripping device is sized and shaped to fit on a surface of a left riding boot.

13. A rider gripping kit comprising first, second, third, fourth, fifth and sixth gripping devices according to claim 1, wherein:
the first gripping device is sized and shaped to fit around a portion of the rider's right lower leg;
the second gripping device is sized and shaped to fit around a portion of the rider's left lower leg;
the third gripping device is sized and shaped to fit around a portion of the rider's right upper leg;
the fourth gripping device is sized and shaped to fit around a portion of the rider's left upper leg;
the fifth gripping device is sized and shaped to fit on a portion of the rider's right buttock; and
the sixth gripping device is sized and shaped to fit on a portion of the rider's left buttock.

14. The rider gripping kit according to claim 13, wherein the first, second, third, fourth, fifth and sixth gripping devices are positioned on an article of apparel worn by the rider.

15. A motor craft gripping kit comprising first, second and third gripping devices according to claim 1, wherein:
the first gripping device is sized and shaped to fit on a portion of a seat of the motor craft;
the second gripping device is sized and shaped to fit on a portion of a first side of a gas tank of the motor craft; and
the third gripping device is sized and shaped to fit on a portion of a second side of a gas tank of the motor craft.

16. A surfboard gripping kit comprising first, second and third gripping devices according to claim 1, wherein:
the first gripping device is positioned on a first portion of the surfboard;
the second gripping device is positioned on a second portion of the surfboard; and
the third gripping device is positioned on a third portion of the surfboard,
wherein the first, second and third gripping devices are separated from each other.

17. A seat gripping kit comprising first and second gripping devices according to claim 1, wherein:
the first gripping device is positioned on a portion of a seat back of the seat; and
the second gripping device is positioned on a portion of a seat bottom of the seat.

18. The seat gripping kit according to claim 17, wherein the seat comprises an object selected from the group consisting of chairs, wheelchairs and car seats.

19. A gripping device comprising:
a traction causing layer comprising a rubber material, the traction causing layer having first and second surfaces, the first surface being textured;
a pressure-sensitive adhesive layer applied to the second surface of the traction causing layer; and
a release liner removably attached to the pressure-sensitive adhesive layer,
wherein the gripping device is sized and shaped to conform to an interface between an object and a portion of a person's body.

20. A gripping device comprising:
a traction causing layer comprising neoprene, the traction causing layer having first and second surfaces, the first surface being textured;
a pressure-sensitive adhesive layer applied to the second surface of the traction causing layer; and
a release liner removably attached to the pressure-sensitive adhesive layer,
wherein the gripping device is sized and shaped to conform to an interface between an object and a portion of a person's body.
